(19) United States
(12) Patent Application Publication
(10) Pub. No.: US 2012/0148723 A1
(43) Pub. Date: Jun. 14, 2012

(54) DRESSING AND METHOD FOR PRODUCING THE SAME

(76) Inventor: Sachiko Matsuda, Fukuoka (JP)

(21) Appl. No.: 13/391,692

(22) PCT Filed: Feb. 1, 2010
(86) PCT No.: PCT/JP2010/051357

§ 371 Date: Feb. 22, 2012

(30) Foreign Application Priority Data
Jan. 25, 2010 (JP) 2010-013444

(51) Int. Cl. A23L 1/24

(52) U.S. Cl. 426/605

(57) ABSTRACT

The purpose of the invention is to provide mayonnaise-like dressing that enables to enjoy the health benefit of egg white simply by consuming as daily food. The disclosed method for producing a dressing comprising the steps of: (1) providing 100 parts by mass of non-heated egg white, 5 to 50 parts by mass of soybean lecithin, 5 to 50 parts by mass of edible vinegar and 150 to 300 parts by mass of cooking oil; (2) adding the soybean lecithin to the egg white and mixing the resultant mixture to form a semisolid having the viscosity of about 30,000 cP-50,000 cP; (3) adding the edible vinegar to the mixture as obtained in step (2) and stirring the resultant mixture; and (4) adding the cooking oil gradually to the mixture as obtained in step (3) and stirring the resultant mixture and a dressing produced by the method. Thus the invention provides excellent protein food containing essential amino acid in 100% of amino acid score.

### TECHNICAL FIELD

The invention relates to a mayonnaise-like dressing and a method for producing the same.

### BACKGROUND ART

According to Japan Agricultural Standards (JAS), a mayonnaise is defined as “semisolid dressing using egg yolk or whole egg, and using no ingredients other than necessary ingredients (oil and vinegar), egg yolk, egg white, hydrolyzed protein, salt, sugars, spices, seasonings (such as amino acids) and acidic ingredients”. Mayonnaise tends to be consumed too much because its greasy feeling is masked by egg and vinegar added. However, the mayonnaise contains high calories because of its high contents of cooking oil, unsaturated fatty acids and acids as well as large amount of cholesterol because of its high contents of egg yolk. For these reasons and the like, those who are on a diet and who need a remedy for lifestyle-related diseases are advised to reduce the intake of mayonnaise. Also the possibility of egg allergy caused by antigen (allergen) in the egg white which may lead to atopic dermatitis and the like is pointed out.

For this, egg-free “Mayonnaise-like dressings” only made from plant-derived ingredients such as soybeans conscious of health and allergy are commercially available.

For example, in Japanese published unexamined application JP 2004-320525 A (hereinafter, abbreviated as Patent Document 1), a method for producing a mayonnaise-like seasoning wherein soymilk or soybean protein (soybean powder) is provided, the soymilk is condensed to the solid content of 15 to 25 mass %, or the soybean protein (soybean powder) is dispersed in water to the solid content of 15 to 25 mass %, the condensed soymilk is homogenized, the amount equivalent to 0.4 to 1.8 parts by mass of acetic acid, 1 to 20 parts by mass of cooking oil, 1 to 3 parts by mass of edible sugar, 1.5 to 5 parts by mass of salt and 0.5 to 3 parts by mass of spices to 70 parts by mass of the condensed and homogenized soymilk and the whole mixture is mixed to homogenize is described.

In Japanese published unexamined application JP 2005-192407 A (hereinafter, abbreviated as Patent Document 2), an emulsified dressing comprising a first ingredient formed from whole fat soybean powder and water as a major component, vinegar or citrus juice, salt and at least one of sugars and spices is described.

In Japanese patent publication JP 4288685 B (hereinafter, abbreviated as Patent Document 3), a soy lecithin dressing comprising a vegetable paste containing onion, carrot, salt and spices, vinegar, vegetable cooking oil, and 20 to 30 weight % of powder separated from the liquid obtained by pressing soybean below 60° C.

In Japanese published unexamined application JP 1994-237734 A (hereinafter, abbreviated as Patent Document 4), a food material for patients with functional disorder comprising a composition containing 40±35 weight % of lipid component containing at least one of 15±10 weight % of eicosapentaenoic acid, 15±10 weight % of docosahexaenoic acid and 20±15 weight % of α-linolenic acid, 30±20 weight % of protein and optionally 10±5 weight % of lecithin component as a major component is described and the use of egg white albumin as protein and the use of soybean lecithin or egg yolk lecithin as the lecithin component is disclosed.

Patent Document 1: Japanese published unexamined application JP 2004-320525 A

Patent Document 2: Japanese published unexamined application JP 2005-192407 A

Patent Document 3: Japanese patent publication JP 4288685 B Patent Document 4: Japanese published unexamined application JP 1994-237734 A

### SUMMARY OF THE INVENTION

### Problems to be Solved by the Invention

All of the mayonnaise-like dressings as described in aforementioned Patent Documents 1-3 are characterized that egg is not used to produce low-fat and low-cholesterol products or to avoid egg allergy.

Among the egg components, egg white, on the contrary to egg yolk, may cause egg allergy. However, egg white is excellent protein food having amino acid score (an index showing whether a protein contains each essential amino acid in good proportion) of 100% and does not contain fat and cholesterol.

To consume essential amino acids in a balanced manner, eating meat and fish blindly is inadequate but a balanced variety of protein foods should be consumed evenly. In one aspect, the use of such consumed foods in the body is controlled by the amount of the least abundant essential amino acid and the excessive amount of essential amino acids are passed out of the body without using.

Especially for growing children, it is necessary to consume sufficient amount of protein. However, consuming good quality of protein required for growing up and consuming sufficient amount of protein having the amino acid score of 100% is very difficult for children with picky eating.

Recently, many women turn to extreme diet owing to rising concern about the beauty and health. Consequently, some cases of anemia and severe health damage are found.

Not only consuming vitamins and minerals from vegetables, consuming balanced nutrition within the calorie allowance is important for healthy diet. Particularly, consuming protein is also important part of losing weight to improve body shape healthily.

The invention according to the aforementioned Patent Document 4 relates to the art for introducing “fish oil” such as eicosapentaenoic acid (EPA) and docosahexaenoic acid (DHA) that are reported to have a therapeutic effect to the brain functional disorder by relieving symptoms and preventing the progression of these diseases to the daily foods.

According to the particular example of the lipid used for the lipid composition of the invention, the lipid composition contains “40±35 weight % of lipid component containing at least one of 15±10 weight % of eicosapentaenoic acid, 15±10 weight % of docosahexaenoic acid and 20±15 weight % of α-linolenic acid”.

Upon preparing the lipid composition under the aforementioned combination ratio of the lipids, EPA and/or DHA are inevitably included in the lipid composition used. Based on the combination ratio, the combination ratio of other ingredients for improving preservability, reducing odor of fish oil and a method for producing a functional food for fulfilling the taste required for food material is described.

Thus the invention according to the Patent Document 4 relates to “the art for improving preservability, quality stability and taste for relieving and preventing the progression of the brain functional disorders”.

On the other hand, egg white not used for the production of conventional mayonnaise using egg yolk, for example, is to be discarded unless it is otherwise used for the production of confectionery or other food products. As large amount of waste egg white from the production process has to be treated as “industrial waste”, it cannot simply be thrown into wastewater.

As mentioned above, egg white, excellent protein food with low cholesterol, is to be made positive use of health maintenance of modern people. Non-heated egg white also contains intact natural enzymes and proteins with antimicrobial activity without destruction.

The use of egg white albumin is as protein is disclosed in the aforementioned Patent Document 4 as well as the soybean lecithin and egg yolk lecithin as lecithin components. Therefore, the invention is not intended to use egg white without using egg yolk because of the possibility of the use of egg yolk. The aim of the invention as described in Patent Document 4 is to supply most lipid component by fish oil.

The purpose of the invention is to provide mayonnaise-like dressing that enables to enjoy the health benefit of egg white simply by consuming as daily food.

### Means to Solve the Problems

The first aspect of the invention to solve the aforementioned problem is a dressing wherein 100 parts by mass of non-heated egg white, 5 to 50 parts by mass of soybean lecithin, 5 to 50 parts by mass of vinegar and 150 to 300 parts by mass of cooking oil are mixed to form an emulsion.

When the amount of soybean lecithin is less than 5 parts by mass per 100 parts by mass of egg white, the dressing remains at emulsified liquid having the viscosity of 5,000 cP-30,000 cP. When the amount of soybean lecithin is more than 50 parts by mass per 100 parts by mass of egg white, although semi-solid product may be obtained, it is too viscous and is inferior in flavor. Therefore, appropriate amount of soybean lecithin is 5-50 parts by mass per 100 parts by mass of egg white.

When the amount of vinegar is less than 5 parts by mass per 100 parts by mass of egg white, the dressing thus obtained is very inferior in flavor. When the amount of vinegar is more than 50 parts by mass per 100 parts by mass of egg white, the product remains at emulsified liquid.

When the amount of cooking oil is less than 150 parts by mass per 100 parts by mass of egg white, the product remains at emulsified liquid. When the amount of cooking oil is more than 300 parts by mass per 100 parts by mass of egg white, the product also remains at emulsified liquid.

When the amount of cooking oil is 150-300 parts by mass per 100 parts by mass of egg white, the semi-solid product may be obtained.

As used herein, the term “vinegar” means liquid food material with sour taste and distinctive flavor including the vinegar as classified by the Quality Labeling Standard for vinegar in the JAS; cereal vinegar such as rice lees vinegar, malt vinegar, rice vinegar, unpolished rice black vinegar, black vinegar, chinkiang vinegar, barley black vinegar and oats vinegar; fruit vinegar such as apple-cider vinegar, grape vinegar, wine vinegar, balsamic vinegar and persimmon vinegar; other brewed vinegar and synthetic vinegar; as well as citrus juice.

As used herein, the term “cooking oil” means any oils served for edible use including salad oil, colza oil, corn oil, soybean oil, sesame oil, rapeseed oil, canola oil, rice oil, rice bran oil, camellia oil, safflower oil, palm oil, coconut, oil, cottonseed oil, sunflower oil, perilla oil, olive oil, peanut oil, almond oil, avocado oil, hazelnut oil, walnut oil, grape seed oil, mustard oil, lettuce oil, fish oil, whale oil, shark oil and liver oil.

The second aspect of the invention is a dressing according to the first aspect of the invention wherein appropriate amounts of one or more additives are added.

A variety of dressings with different flavors may be produced herewith.

The third aspect of the invention is a method for producing a dressing comprising the steps of:
(1) providing 100 parts by mass of non-heated egg white, 5 to 50 parts by mass of soybean lecithin, 5 to 50 parts by mass of vinegar and 150 to 300 parts by mass of cooking oil;
(2) adding the soybean lecithin to the egg white and mixing the resultant mixture to form a semisolid having the viscosity of about 30,000 cP-50,000 cP;
(3) adding the vinegar to the mixture as obtained in step (2) and stirring the resultant mixture; and
(4) adding the cooking oil gradually to the mixture as obtained in step (3) and stirring the resultant mixture.

The fourth aspect of the invention is a method for producing a dressing according to the third aspect of the invention wherein the temperature of each gradient in step (1) is adjusted between 0-10° C. and steps (2)-(4) are performed under that temperature. A mayonnaise-like emulsion may be achieved by providing and stirring each ingredient within the aforementioned temperature range.

When the temperature exceeds 10° C., the emulsion remains at liquid and hardly forms semi-solid.

The dressing of the invention is an emulsion-type dressing, a mayonnaise-like dressing, obtained by adding soybean lecithin to egg white, followed by vinegar and cooking oil and stirring the mixture.

Egg white contains essential amino acids for human with the amino acid score of 100% as well as various antimicrobial components.

Such components in egg-white protect embryo in egg yolk from microorganisms such as bacteria invading through egg shell. They include proteins having various antimicrobial activities such as lysozyme, an enzyme having “bacteriolytic action” of lysing invading microorganisms (egg white is also used for the production of medicine for colds), ovomocoid and ovoinhibitor that inhibit the action of protease of invading microorganisms and conalbumin that bind to iron (Fe) to inhibit growth of invading microorganisms.

Although it may cause egg allergy, consuming egg white is highly advantageous for healthy individuals because it contains essential amino acids for human with the amino acid score of 100% as well as various antimicrobial components.

The art that enables to consume nutrition and enzymes without destroying by heating in the form of dressing may contribute significantly to health.

Indeed, some people have allergy to egg white. However, the advantage of the invention is that it provides excellent protein food containing essential amino acid in 100% of amino acid score.

### Effect of the Invention

The invention provides a mayonnaise-like dressing that enables to enjoy the health benefit of egg white simply by consuming as daily food by adding 5 to 50 parts by mass of soybean lecithin to 100 parts by mass of egg white and mixing the resultant mixture; adding 5 to 50 parts by mass of vinegar to the mixture and stirring the resultant mixture; and adding 150 to 300 parts by mass of cooking oil gradually to the mixture and stirring the resultant mixture.

### EMBODIMENTS OF THE INVENTION

Embodiments of the invention are illustrated hereinbelow.

Better emulsification of final product may be achieved by mixing soybean lecithin to the amount of egg white used just before the production.

The term “better emulsification” means that high viscosity of the final product may be achieved.

Herein, according to quality standard of the product of the invention, the viscosity of 5,000 cP to 30,000 cP is referred to as emulsified liquid and the viscosity of 30,000-50,000 cP is referred to as semi-solid.

As mentioned above, semi-solid .having the viscosity of 30,000 cP-50,000 cP can readily be formed by adding soybean lecithin to egg white.

The product that emulsified into “semi-solid” does not separate during the storage period of about 2 weeks at room temperature and at low temperature of 3 to 10° C.

Better emulsification of final product may be achieved by cooling the mixture of the soybean lecithin and egg white, vinegar and cooking oil used at 0 to 10° C. upon the production.

### Example

5 to 50 parts by mass of soybean lecithin (powder), 5 to 50 parts by mass of vinegar and 150 to 300 parts by mass of cooking oil are provided per 100 parts by mass of egg white.

Aforementioned amount of all ingredients are cooled to about 10° C. Vinegar is added to the mixture of egg white and soybean lecithin and stirring is commenced. To the mixture thus obtained, cooking oil is added in small portions.

Preferably, cooking oil is added to the mixture so that one percent portion of cooking oil is mixed into the mixture every 3 to 5 seconds.

Accordingly, the mixture of the ingredients is emulsified to semi-solid, which makes its texture mild, masks its sour taste and enhances its flavor.

### Comparative Example

Temperature of aforementioned amount of all ingredients is adjusted to about 25° C. Vinegar is added to the mixture of egg white and soybean lecithin and stirring is commenced. To the mixture thus obtained, cooking oil is added in small portions.

Cooking oil is added in the manner similar to that as described in Example.

The mixture of the ingredients thus obtained remains at emulsified liquid and separates in several hours at room temperature and even at low temperature below 10° C.

These results show that preferable temperature for preparation and processing the ingredients is about 10° C.

In addition to the aforementioned ingredients, appropriate amounts of additive including spices such as cinnamon, pepper, clove, peppermint, bay leaf, ginger, mustard and Japanese pepper; foodstuff such as garlic, tea and laver; other additives such as miso, soy sauce and rock salt may be added, which provides the mayonnaise-like dressing with various flavors.

### INDUSTRIAL APPLICABILITY

The invention may be preferably applied to food production as a mayonnaise-like dressing that enables one to enjoy the health benefit of egg white simply by consuming as daily food.

1. A dressing wherein 100 parts by mass of non-heated egg white, 5 to 50 parts by mass of soybean lecithin, 5 to 50 parts by mass of vinegar and 150 to 300 parts by mass of cooking oil are mixed to form an emulsion.

2. A dressing according as claimed in claim 1, wherein appropriate amounts of one or more additives are added.

3. A method for producing a dressing comprising the steps of:
(1) providing 100 parts by mass of non-heated egg white, 5 to 50 parts by mass of soybean lecithin, 5 to 50 parts by mass of vinegar and 150 to 300 parts by mass of cooking oil;
(2) adding the soybean lecithin to the egg white and mixing the resultant mixture to form a semisolid having the viscosity of about 30,000 cP-50,000 cP;
(3) adding the vinegar to the mixture as obtained in step (2) and stirring the resultant mixture; and
(4) adding the cooking oil gradually to the mixture as obtained in step (3) and stirring the resultant mixture.

4. A method for producing a dressing as claimed in claim 3, wherein the temperature of each gradient in step (1) is adjusted between 0-10° C. and steps (2)-(4) are performed under that temperature.
